(19) United States
(12) Patent Application Publication
(10) Pub. No.: US 2012/0272806 A1
(43) Pub. Date: Nov. 1, 2012

(54) CUTTING DEVICE HAVING VARIABLE LATERAL GUIDING

(75) Inventors: Thomas Baur, Hilchenbach (DE); Klaus Bäumer, Kreuztal (DE)

(73) Assignee: SMS Siemag Aktiengesellschaft, Dusseldorf (DE)

(21) Appl. No.: 13/502,506

(22) PCT Filed: Oct. 15, 2010
(86) PCT No.: PCT/EP2010/006308

§ 371 Date: Jul. 17, 2012

(30) Foreign Application Priority Data
Oct. 17, 2009 (DE) 10 2009 049 743.9

(51) Int. Cl. B23D 15/04; B23P 17/00

(52) U.S. Cl. 83/561; 29/401.1

(57) ABSTRACT

The invention relates to a cutting device, in particular a crosscutting shearing machine, longitudinal cutting shearing machine or roller cut shearing machine for cutting metal sheets, and to a method for controlling such a device, the device comprising a top blade 1 and a bottom blade 2 and at least one drive device 4, which is connected to the top and/or the bottom blade 1, 2 in order to drive the cutting operation, the device having a lateral guide 3, 3′ for guiding the top knife 1, the length of which guide is designed to be adjustable. By means of such an adjustable-length lateral guide 3, 3′, an adjustable overlap is made possible and, inter alia, an optimal rolling cut movement for various thicknesses of a sheet to be cut is ensured.

### FIELD OF THE INVENTION

The invention relates to a cutting device, particularly a transverse cutting shear, a longitudinal cutting shear, or rolling cut (trimming) shear for cutting sheet metal in accordance with the preamble of claim 1.

### STATE OF THE ART

A double trimming shear with a stationary bottom blade is known from WO 2008/037239 A1, wherein the respective upper blade is driven by eccentric shafts through connecting rods so as to be able to be raised and lowered. Each connecting rod is arranged on an eccentric shaft, wherein the upper blade, due to different crank radii, due to the offset thereof and different connecting rod lengths, carries out a rolling cut movement which is guided by a sliding block. Although, even the length of connecting et this drive mechanism can be changed, the field of use of this shear is very limited. In the indicated construction, it is primarily the stationary lateral articulated connection of the upper blade to one of its ends that has a negative effect. Consequently, a cut of high quality can only be made possible for a relatively limited thickness range. Moreover, the cutting device can only be used for limited sheet metal widths.

WO 2008/135127 A1 shows another cutting device for cutting sheet metal plates, with a first cutting blade of an upper blade and a second cutting blade of a lower blade, which additionally includes a drive device with at least two rotatably drivable eccentric shafts which are connected from above to the first cutting blade by means of connecting elements, wherein at least one of the connecting elements is constructed so that its length is adjustable between the drive of the blade and the upper blade. The device disclosed in this document has similar disadvantages as the device according to the previously described document. Again, the upper blade is articulated laterally in such a way that a rolling movement cannot be realized for many sheet metal thicknesses and widths. The cutting movement is the same for all sheet metal thicknesses and limits the cutting thickness of the machine. However, it would be desirable to make it possible to adapt the cutting movement to the sheet metal thickness in order to achieve good cutting results. In particular in thick materials, a poor quality of the cut is found. In particular, in the case in the document first cited, cutting arches and bending of the sheet metal end could not be avoided in larger sheet metal thicknesses.

FIG. 1a shows another example from the state of the art which is guided by means of a rotatable guide rod 30. The upper blade 10 is in this case once again moved by two electromechanical drives 40 which each have connecting rods which are adjustable over the length thereof. However, the lateral articulated connection 30 is effected with a fixed length. The ideal rolling movement can be structurally determined only for a fixed immersion depth of the upper blade 10. This results in deformations of the sheet metal (for example cutting arches) and a general reduction of the quality of the cuts.

FIG. 1b shows another example of a cutting device from the state of the art which shows a system composed of an upper and a lower blade 10, 20, wherein the upper blade 10 is hydraulically driven (41) and is again laterally articulated with a fixed length.

Finally, FIG. 1c shows a similar cutting device as the one shown in FIG. 1b, however, with a hydraulic drive 42 which combines connects the lower and upper blades 20, 10 to each other. The resulting disadvantages are the same as in the devices mentioned above.

In view of the state of the art explained above, it is the technical object to make available a cutting device which avoids at least one of the above mentioned disadvantages, or which further develops the above mentioned devices.

### DISCLOSURE OF THE INVENTION

The technical object is met by the cutting device according to the invention, particularly a transverse cutting shear, a longitudinal cutting shear or a rolling cut shear for cutting sheet metal, which comprises an upper blade and a lower blade as well as at least one drive device which is connected to the upper blade and/or the lower blade for driving the cutting procedure, and wherein the device comprises a lateral guidance for guiding the upper blade whose length is constructed so as to be adjustable in its longitudinal direction. Consequently, the excess cut of the blades is adjustable. Because of the possibility of longitudinally adjusting the lateral guidance according to the invention, it is now possible to ensure a better quality of the cut. This refers primarily to cuts in different sheet metal widths and thicknesses. In accordance with the invention, the spectrum of cutting widths and thicknesses can be significantly expanded. The above mentioned disadvantages can be for the most part avoided.

In accordance with a preferred embodiment of the cutting device, the lateral guidance is at one end connected to the upper blade, and at another end, to a articulation point which is arranged laterally of the upper blade.

In accordance with another preferred embodiment of the cutting device, the lateral guidance includes an adjusting element for adjusting the length.

In accordance with another preferred embodiment of the cutting device, the lateral guidance comprises a rotatable cam disk, so that the length of the lateral guidance can be adjusted.

In accordance with another preferred embodiment of the cutting device, the lateral guidance comprises a sliding block whose guide track is constructed so as to be changeable with respect to space such that the lateral guidance can be adjusted along the length thereof.

In accordance with another preferred embodiment of the cutting device, the lateral guidance comprises hydraulic or pneumatic means for length adjustment the lateral guidance.

In accordance with another preferred embodiment of the cutting device, the lateral guidance comprises electromechanical means for the length adjustment of the lateral guidance.

In accordance with another preferred embodiment of the cutting device, the lateral guidance comprises a threaded rod or a threaded spindle and at least one, preferably two, threaded sleeves, which are constructed in such a way that the length of the lateral guidance is adjustable.

In accordance with another preferred embodiment of the cutting device, the cutting device is constructed in such a way that the lateral guidance comprises a connecting element which at one end is connected to the upper blade, and at another end to an articulation point or a shaft.

In accordance with another preferred embodiment of the cutting device, the connecting element is constructed at the other end so as to be mechanically drivable and is supported in particular at a rotatably drivable eccentric shaft.

In accordance with another preferred embodiment of the cutting device, the connecting element is supported on the eccentric shaft at an eccentrically adjustable articulated connection.

The invention further relates to a method for controlling a cutting device, particularly a transverse cutting shear, a longitudinal cutting shear, or rolling cutting shear for cutting sheet metal, which includes an upper blade and a lower blade, as well as at least one drive device which is connected to the upper blade and/or the lower blade for driving the cutting procedure, and wherein the cutting device comprises a lateral guidance for guiding the upper blade, which can be longitudinally adjusted. The advantages of the method according to the invention correspond essentially to those of the device according to the invention.

In accordance with another preferred embodiment of the method, the lateral guidance is adjusted such that during the cutting procedure, a rolling movement, particularly a continuous rolling movement, is ensured.

In accordance with another preferred embodiment of the method, for adjusting the lateral guidance, at least one of the following parameters is taken into consideration: Cutting angle, immersion depth of the upper blade, material thickness, material width, and/or material properties. By taking into consideration these parameters, together with the length adjustment of the lateral guidance, a cut of high quality can be achieved.

### BRIEF DESCRIPTION OF THE FIGURES

In the following, the Figures of the embodiments are briefly described. Further details can be found in the detailed description of the embodiments. In the drawing:

FIG. 1a shows a cutting device of the prior art with lateral articulated connection;

FIG. 1b shows another example of a cutting device with lateral articulated connection of the prior art;

FIG. 1c shows another example of a cutting device with lateral articulated connection of the prior art;

FIG. 2 shows an embodiment of a cutting device according to the invention with a hydraulically adjustable lateral articulated connection;

FIG. 3 shows another embodiment of a cutting device according to the invention with eccentrically adjustable lateral guidance.

### DETAILED DESCRIPTION OF THE EMBODIMENTS

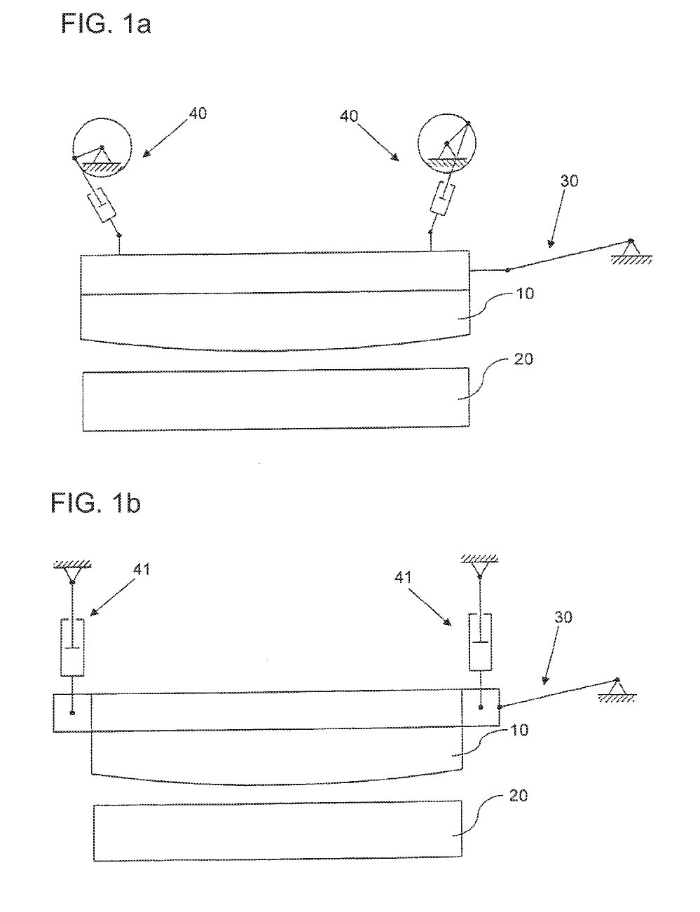

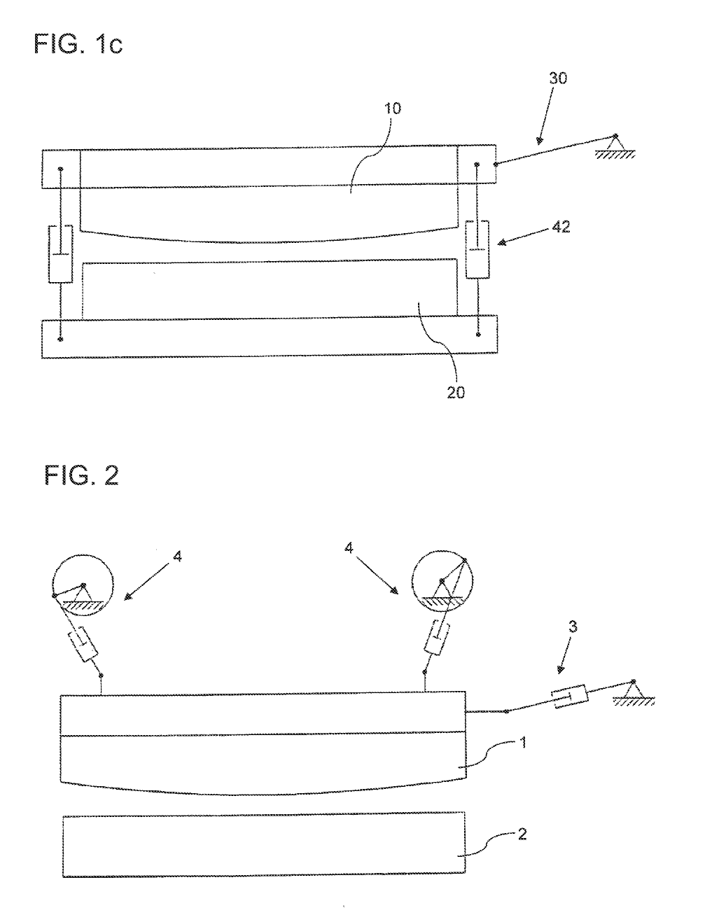

An embodiment of a shear according to the invention is illustrated in FIG. 2. The upper blade 1 is connected at its upper side to conventional drive units 4. The lower blade 2 is fixedly mounted in the embodiment however, it may also be constructed so as to be moveable. In contrast to the shears of the prior art shown in FIGS. 1a to 1c, the upper blade 1 has a lateral guidance 3 which is adjustable or changeable along its length. This lateral guidance 3 is arranged laterally of the upper blade 1, preferably essentially in the direction of the longitudinal axis of the upper blade 1. In particular, the lateral guidance 3 is preferably connected at one end to the upper blade 1 and at another end to an articulation point which is located laterally of the upper blade 1. In addition, an articulation point of the lateral guidance 3 may preferably be provided on the upper blade 1 and at different levels of the side of the upper blade 1. This is also true for the articulation point located laterally of the upper blade 1 at the other end of the lateral guidance 3. Because of the lateral guidance whose length is adjustable, a rolling movement of the upper blade 1 can be ensured for all states of operation of the cutting movement. This is also true if, for example, the lengths of the connecting rods of the drive 4 can be varied or eccentric shafts are used at the drives 4. In the case of FIG. 2, the changeable lateral guidance 3 is ensured by hydraulic or pneumatic piston/cylinder units. Other possibilities for adjusting the lateral guidance 3 are available, for example, by a spatially changeable guide track for at least one sliding block or by using a generally known rotatable cam disk for lateral guidance. In particular, when using a piston/cylinder unit, it is possible to continuously adjust the length of the guide member.

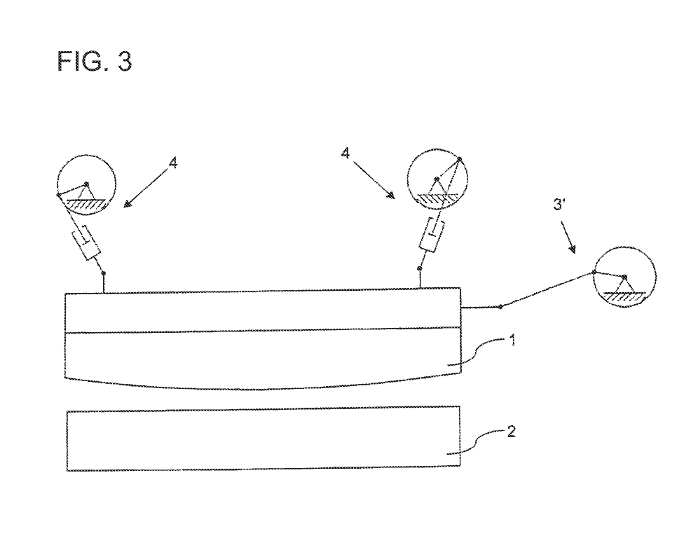

Another possibility according to the invention for providing a laterally changeable articulation connection is illustrated in FIG. 3. The construction is essentially analogous to the construction of FIG. 2. However, a guide member with a preferably electromechanically changeable length is used, wherein an eccentric is used for this purpose. Such eccentric systems per se are known to those skilled in the art, as also intended for the drives 4. However, the adjustable lateral guidance 3′ of FIG. 3 may also include, additionally or alternatively, a spindle, wherein preferably two nuts are mounted in the guide member, whose length can be infinitely variably adjusted by turning the nuts of the spindle. Generally, the features of the embodiments of the invention can be combined with each other.

The devices according to the invention make possible a variation of the excess cut of the blades 1, 2 or of the overlap of the blades 1, 2 so that significantly better cutting results, primarily at the cut edges, are obtained than is the case in known shears.

### LIST OF REFERENCE NUMERALS

1 Upper blade
2 Lower blade
3 Lateral guidance with hydraulic adjustment
3′ Lateral guidance with eccentric adjustment
4 Drive
10 Upper blade
20 Lower blade
30 Articulated connection with fixed length
40 Drive
41 Drive
42 Drive

1-14. (canceled)

15. A cutting device for cutting sheet metal, comprising: an upper blade; a lower blade; at least one drive device which is connected to the upper blade and/or the lower blade for driving the cutting procedure; and a lateral guidance for guiding the upper blade, the lateral guidance having an adjustable length.

16. The cutting device according to claim 15, wherein the lateral guidance has one end connected to the upper blade and another end connected to an articulation point arranged laterally of the upper blade.

17. The cutting device according to claim 15, wherein the lateral guidance includes an adjusting element for the length adjustment.

18. The cutting device according to claim 15, wherein the lateral guidance comprises a rotatable cam disk constructed so that the lateral guidance has an adjustable length.

19. The cutting device according to claim 15, wherein the lateral guidance includes at least one sliding block having a guide track constructed so as to be spatially changeable, so that the lateral guidance has an adjustable length.

20. The cutting device according to claim 15, wherein the lateral guidance comprises hydraulic or pneumatic means for adjusting the length of the lateral guidance.

21. The cutting device according to claim 15, wherein the lateral guidance comprises electromechanical means for adjusting the length of the lateral guidance.

22. The cutting device according to claim 15, wherein the lateral guidance comprises a threaded rod or a threaded spindle and at least one threaded sleeve, which are constructed so that the lateral guidance has an adjustable length.

23. The cutting device according to claim 22, wherein the lateral guidance includes two threaded sleeves.

24. The cutting device according to claim 15, wherein the lateral guidance comprises a connecting element having one end connected to the upper blade and another end connected to an articulation point or a shaft.

25. The cutting device according to claim 24, wherein the connecting element is constructed so as to be mechanically drivable at the another end.

26. The cutting device according to claim 25, and further comprising a rotatably drivable eccentric shaft, the another end of the connecting element being mounted to the eccentric shaft.

27. The cutting device according to claim 26, wherein the connecting element is mounted at the eccentric shaft by an eccentrically adjustable articulation connection.

28. A method for controlling a cutting device for cutting sheet metal, which comprises an upper blade and a lower blade and at least one drive device which is connected to the upper blade and/or the lower blade for driving cutting procedure, and wherein the cutting device comprises a lateral guidance for guiding the upper blade, the method comprising the step of adjusting the length of the lateral guidance.

29. The method according to claim 28, including adjusting the lateral guidance so that, during the cutting procedure, a rolling movement is ensured.

30. The method according to claim 29, wherein the rolling movement is continuous.

31. The method according to claim 28, including adjusting the lateral guidance by taking into consideration at least one of the following parameters: cutting angle, immersion depth of the upper blade, thickness of the sheet metal, width of the sheet metal and material properties of the sheet metal.
